(19) United States
(12) Patent Application Publication
(10) Pub. No.: US 2025/0317398 A1
(43) Pub. Date: Oct. 9, 2025

(54) Handling Of In-Order Delivery And Latency Variation In Mobile Communications

(71) Applicant: MediaTek Singapore Pte. Ltd., Singapore (SG)

(72) Inventor: Jarkko Eskelinen, Oulu (FI)

(21) Appl. No.: 19/172,604

(22) Filed: Apr. 7, 2025

Related U.S. Application Data
(60) Provisional application No. 63/575,868, filed on Apr. 8, 2024.

(51) Int. Cl. H04L 47/20; H04L 1/1812; H04L 45/64

(52) U.S. Cl. CPC H04L 47/20; H04L 1/1812; H04L 45/64

(57) ABSTRACT

Techniques pertaining to handling of in-order delivery and latency variation in mobile communications are described. An apparatus (e.g., a user equipment (UE)) receives one or more packets from a network and evaluates a local application-specific forwarding policy. The apparatus then forwards at least one packet of the one or more packets to an application according to the application-specific forwarding policy.

### CROSS REFERENCE TO RELATED PATENT APPLICATION(S)

The present disclosure claims the priority benefit of U.S. Patent Application No. 63/575,868, filed 8 Apr. 2024, the content of which herein being incorporated by reference in its entirety.

### TECHNICAL FIELD

The present disclosure is generally related to mobile communications and, more particularly, to handling of in-order delivery and latency variation in mobile communications.

### BACKGROUND

In wireless communications such as mobile communications under the current 3^{rd} Generation Partnership Project (3GPP) specification, there are requirements pertaining to the Packet Data Convergence Protocol (PDCP) in-order delivery. That is, packets must be delivered to the higher protocol layers in the exact order they were transmitted. This is crucial for maintaining the sequence of data and ensuring data integrity. As hybrid automatic repeat request (HARQ) retransmissions, due to errors or poor channel conditions, can introduce additional delay, it affects the in-order delivery as subsequent packets must wait for the retransmitted packet to be successfully received. With respect to user experience, services sensitive to delay, such as real-time video streaming, online gaming, and voice over Internet Protocol (VoIP), can be negatively impacted by latency variation caused by HARQ retransmissions.

In view of the above, there exist several ways to mitigate latency variation. For example, to improve user experience, adaptive modulation and coding may be one of the techniques implemented. Othe techniques may include pre-emptive scheduling, prioritization, buffer management cross-layer optimization, and enhanced HARQ feedback. However, at the time of the present disclosure, there does not exist any application-controlled policy to help latency-sensitive applications to cope with HARQ and other retransmission scheme-related latency variation in conjunction with in-order delivery requirement. Therefore, there is a need for a solution of handling of in-order delivery and latency variation in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to handling of in-order delivery and latency variation in mobile communications. It is believed that implementations of one or more of the schemes proposed herein may address or otherwise alleviate the issues described above. For instance, under the proposed schemes in accordance with the present disclosure, a policy may be implemented such that an application can request out-of-order delivery from a device (e.g., a user equipment (UE)) in case that the application can cope with out-of-order data flow. Advantageously, this may allow reception of service data units (SDUs) at the application level immediately (e.g., without delay) when they are received by the UE, without waiting for reordering of packets.

In one aspect, a method may involve a processor of a UE receiving one or more packets from a network. The method may also involve the processor evaluating a local application-specific forwarding policy. The method may further involve the processor forwarding at least one packet of the one or more packets to an application according to the application-specific forwarding policy.

In another aspect, an apparatus implementable in a UE may include a transceiver configured to communicate wirelessly and a processor coupled to the transceiver. The processor may receive one or more packets from a network. The processor may also evaluate a local application-specific forwarding policy. The processor may further forward at least one packet of the one or more packets to an application according to the application-specific forwarding policy.

It is noteworthy that, although the description provided herein may be in the context of certain radio access technologies, networks, and network topologies such as 5G NR/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4G/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a block diagram of an example communication system under a proposed scheme in accordance with the present disclosure.

FIG. 8 is a flowchart of a second example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling of in-order delivery and latency variation in mobile communications. According to the present disclosure, a number of possible solutions may be implemented separately or jointly. That is, although these possible solutions may be described below separately, two or more of these possible solutions may be implemented in one combination or another.

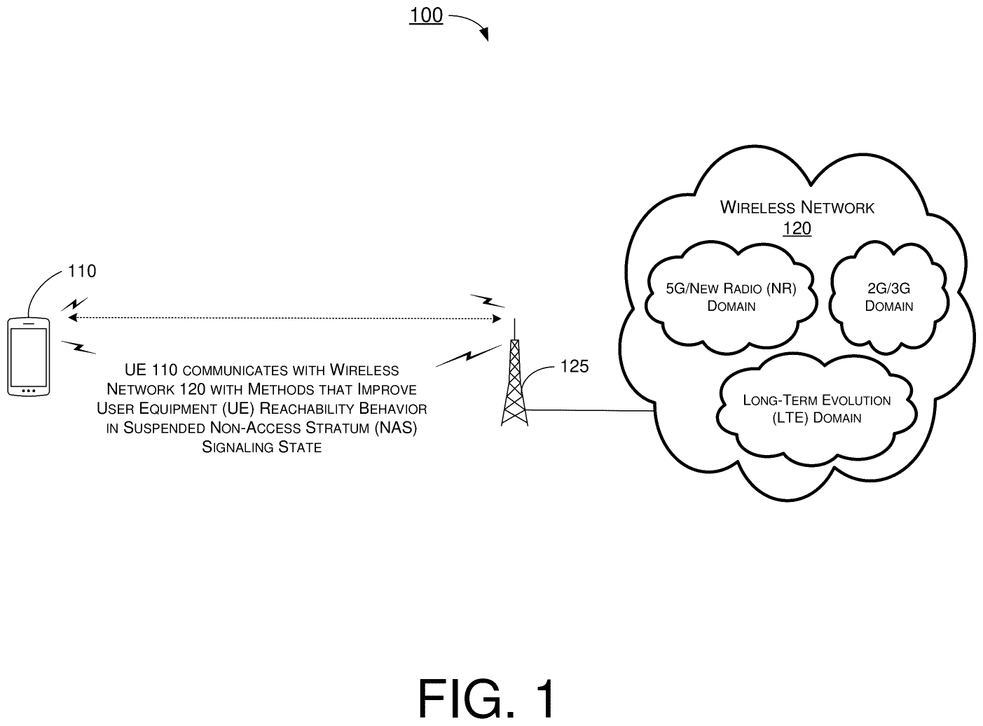

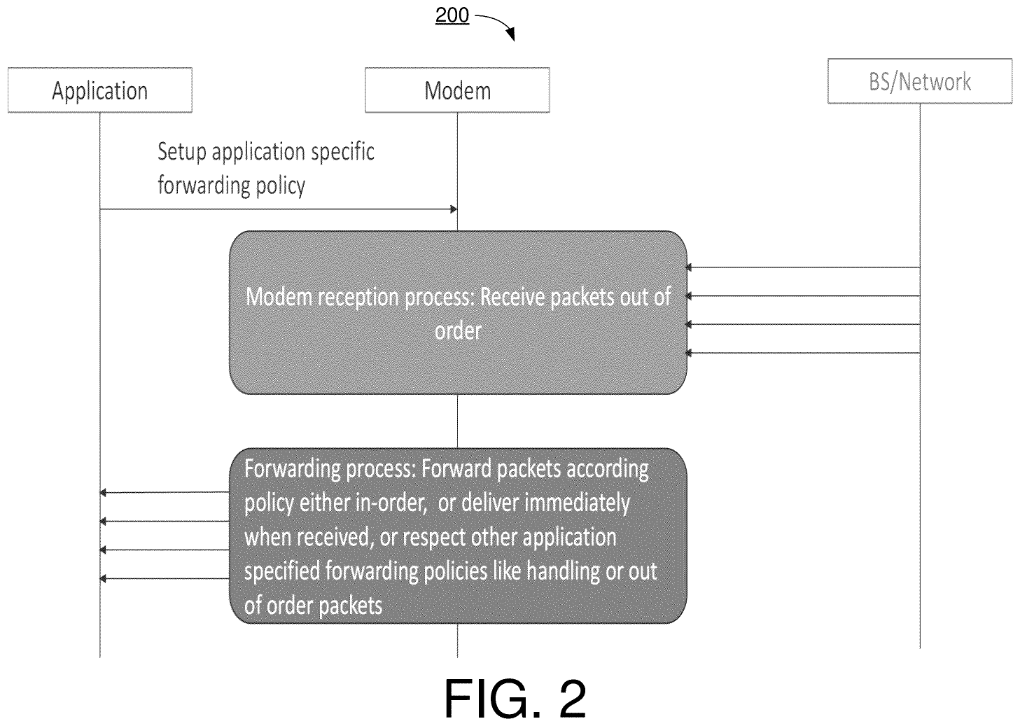

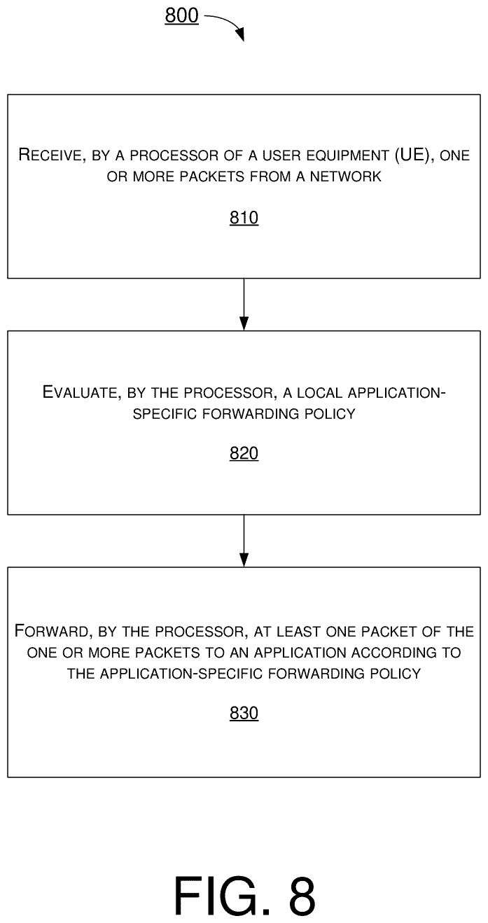

FIG. 1 illustrates an example network environment 100 in which various solutions and schemes in accordance with the present disclosure may be implemented. FIG. 2˜ FIG. 8 illustrate examples of implementation of various proposed schemes in network environment 100 in accordance with the present disclosure. The following description of various proposed schemes is provided with reference to FIG. 1˜ FIG. 8.

Referring to FIG. 1, network environment 100 may involve a UE 110, such as a mobile device or smartphone, in wireless communication with a wireless network 120 as part of a communication network. The wireless network 120 may be one or more public land mobile networks (PLMNs) including 5G/NR domain, 4G/LTE domain, and 2^{nd} Generation/3^{rd} Generation (2G/3G) domain. UE 110 may initially be in wireless communication with wireless network 120 via a base station or network node 125 (e.g., an eNB, gNB, transmit-receive point (TRP) or a non-terrestrial network node such as a satellite). In network environment 100, UE 110 and the wireless network 120 may implement various schemes pertaining to handling of in-order delivery and latency variation in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under various proposed schemes in accordance with the present disclosure, an application-controlled policy may be introduced to help latency-sensitive applications to cope with HARQ and other retransmission scheme-related latency variation in conjunction with in-order delivery requirement. Under this application-controlled policy, an application may request out-of-order delivery from a device (e.g., UE 110) in case the application can cope with out-of-order data flow. This may allow reception of SDUs at the application level immediately (e.g., without delay) when they are received by UE 110, without waiting for reordering of packets.

As an implementation example, without any direct application-to-modem link, an application may request a modem (e.g., UE 110) by using Attention command(s) (also known as AT command(s)), or other request(s), to ignore the in-order delivery requirement for SDUs matching a flow filter given by the application in the request. For example, the modem or UE 110 may apply a requested delivery policy to matching SDUs.

As an implementation example, with a host-based interface, a host operating system or other software component may offer an application programming interface (API) to request a modem (e.g., UE 110) to implement out-of-order forwarding for SDUs matching a provided flow filter. For example, the modem or UE 110 may implement a requested policy for SDUs and may perform out-of-order forwarding.

As another implementation example, a host may set up a virtual connection or related filter with a policy to adjust modem forwarding policy for received packets. For instance, an explicit policy such as “immediate lossless delivery” or “reliable delivery” may be implemented. Alternatively, or additionally, a policy for maximum reordering delay for packets, where modem may use a t-reorder timer or similar mechanisms, may be implemented. Alternatively, or additionally, in an uplink direction, a policy of using a t-discard timer to discard data that is too old such that an application does not want to forward. Further, the modem or UE 110 may communicate application t-discard and t-reorder parameters to wireless network 120 using an appropriate mechanism specific for this purpose. The main idea here is to implement a channel for the application to control modem packet forwarding policies regarding retransmission and, thus, reordering latencies. This may also impact link reliability (not just one link but also multiple links over a long distance).

Under the proposed schemes, with respect to router user case, a user may configure an out-of-order forwarding policy using a router product user interface (local and/or remote) to forward packets matching a match rule using out-or-order policy. The router may implement the requested policy as instructed.

FIG. 2 illustrates an example scenario 200 under a proposed scheme in accordance with the present disclosure. Scenario 200 may pertain to a high-level concept of the present disclosure. Referring to FIG. 2, an application may set up an application-specific forwarding policy for a modem (e.g., UE 110). In operation, the modem may receive packets out of order from a base station (BS), such as network node 125 of wireless network 120. As for the forwarding process, the modem may forward the received packets according to the policy, either forward the packets in-order, forward the packets immediately upon receipt without any delay, or respect other application-specific forwarding policies such as handling of out-of-order packets.

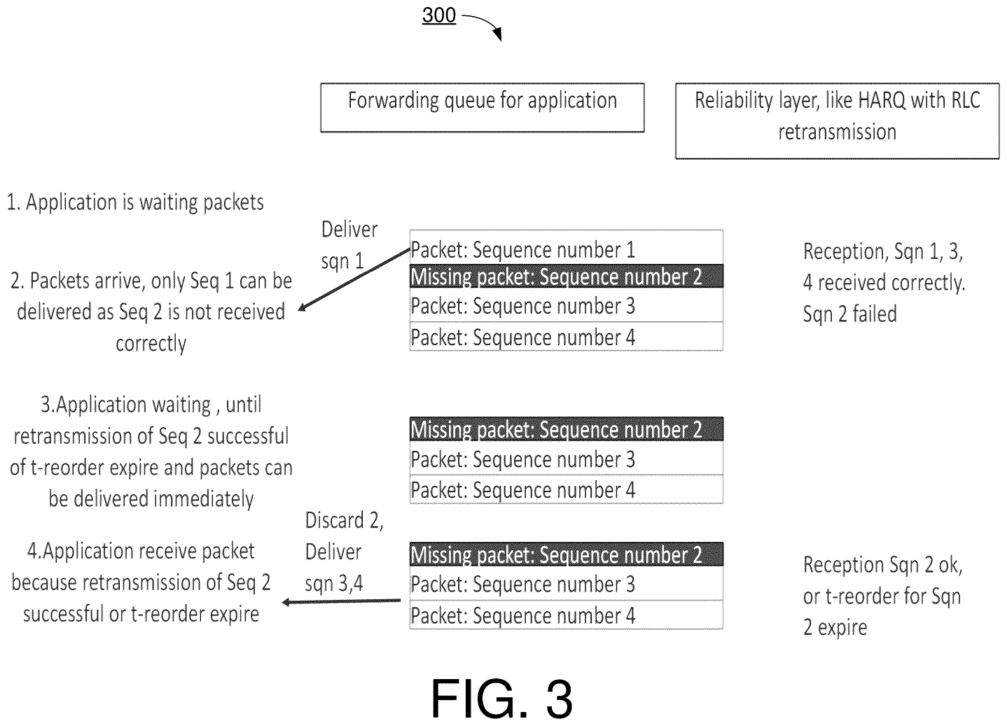

FIG. 3 illustrates an example scenario 300 under a proposed scheme in accordance with the present disclosure. Scenario 300 may pertain to a scenario without a deliver policy. Referring to FIG. 3, initially, an application may be waiting for packets. Then, packets of sequence number 1, sequence number 3 and sequence number 4 arrive, but not packets of sequence number 2. As such, only packets of sequence number 1 may be delivered to the application as packets of sequence number 2 have not been received correctly or are otherwise missing. The application thus may keep waiting until retransmission of packets of sequence number 2 is successful or t-reorder timer for sequence number 2 expires and packets may be delivered immediately without any delay. In the end, the application may receive packets of sequence numbers 3 and 4 because retransmission of sequence number 2 is successful or t-reorder timer for sequence number 2 expires.

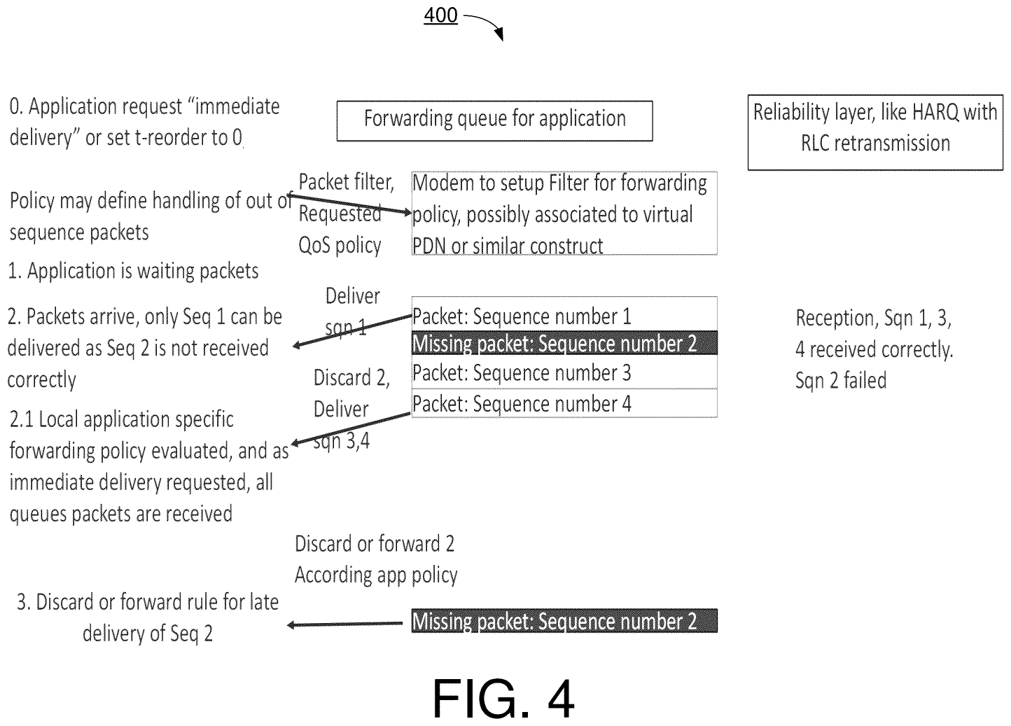

FIG. 4 illustrates an example scenario 400 under a proposed scheme in accordance with the present disclosure. Scenario 400 may pertain to a scenario with a UE local delivery policy which is not communicated to a network. Referring to FIG. 4, an application may request “immediate delivery” or set t-reorder timer to 0. The policy may define handling of out-of-sequence packets. Accordingly, a modem (e.g., UE 110) may set up a filter for forwarding policy, possibly associated to a virtual packet data network (PDN) or similar construct. In operation, the application may be waiting for packets. Then, packets of sequence number 1, sequence number 3 and sequence number 4 arrive, but not packets of sequence number 2. As such, only packets of sequence number 1 may be delivered to the application as packets of sequence number 2 have not been received correctly or are otherwise missing. Accordingly, a local application-specific forwarding policy may be evaluated, and as “immediate delivery” is requested, all queues of packets (e.g., packets of sequence number 1, sequence number 3 and sequence number 4) may be delivered to the application. Depending on application's policy, packets of sequence number 2, when received, may be discarded or forwarded to the application.

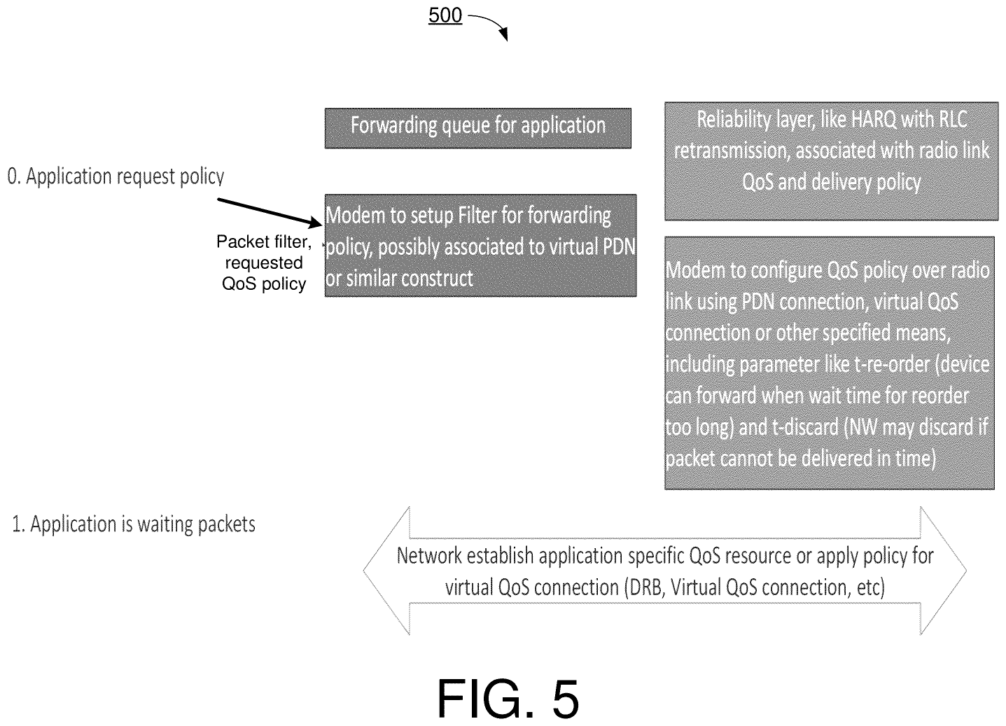

FIG. 5 illustrates an example scenario 500 under a proposed scheme in accordance with the present disclosure. Scenario 500 may pertain to a scenario with a system delivery policy which is communicated to a network. Referring to FIG. 5, a modem (e.g., UE 110) may set up a filter for forwarding policy, possibly associated to a virtual PDN or similar construct. The modem may configure quality of service (QOS) policy over radio link using PDN connection, virtual QoS connection or other specified means, including parameter(s) such as values of t-reorder (e.g., UE 110 may forward when wait time for reordering is too long) and t-discard (e.g., network 120 may discard if packet cannot be delivered in time). In operation, an application may request for the policy and wait for packets. The network may establish an application-specific QoS resource or may apply the policy for virtual QoS connection (data radio bearer (DRB), virtual QoS connection, and such).

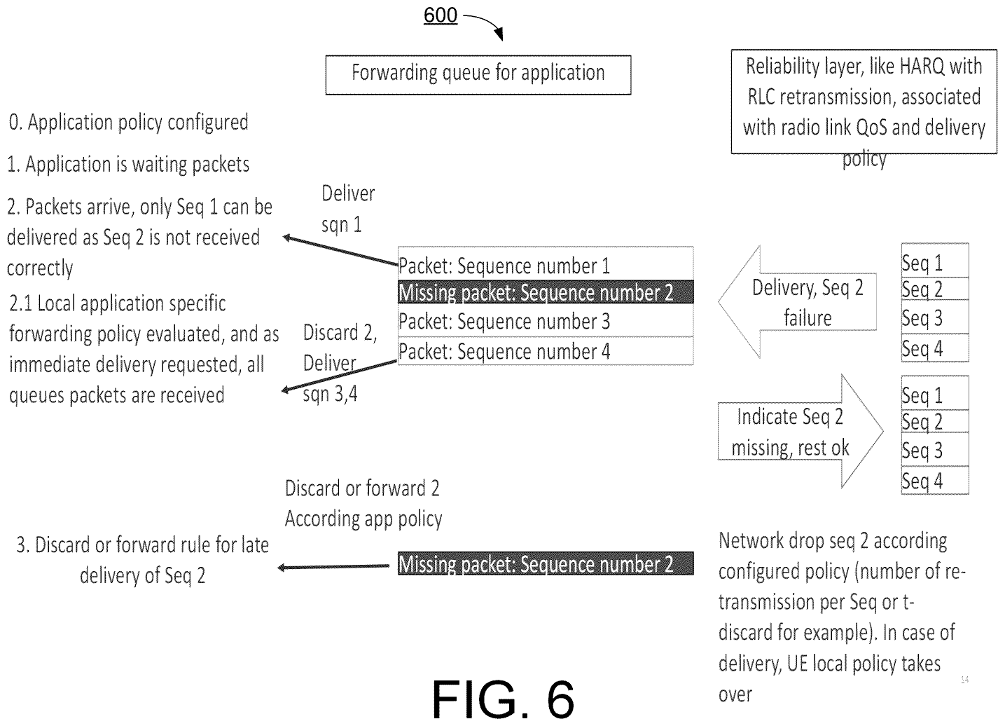

FIG. 6 illustrates an example scenario 600 under a proposed scheme in accordance with the present disclosure. Scenario 600 may pertain to another scenario with a system delivery policy which is communicated to a network. Referring to FIG. 6, an application policy may be configured. The application may be waiting for packets. Then, packets of sequence number 1, sequence number 3 and sequence number 4 arrive, but not packets of sequence number 2. As such, only packets of sequence number 1 may be delivered to the application as packets of sequence number 2 have not been received correctly or are otherwise missing. Accordingly, a local application-specific forwarding policy may be evaluated, and as “immediate delivery” is requested, all queues of packets (e.g., packets of sequence number 1, sequence number 3 and sequence number 4) may be delivered to the application. Depending on application's policy, packets of sequence number 2, when received, may be discarded or forwarded to the application. In this scenario, the network may drop sequence number 2 according to the configured policy (e.g., number of retransmission per sequence or t-discard for example). In case of delivery, a UE local policy may take over.

### Illustrative Implementations

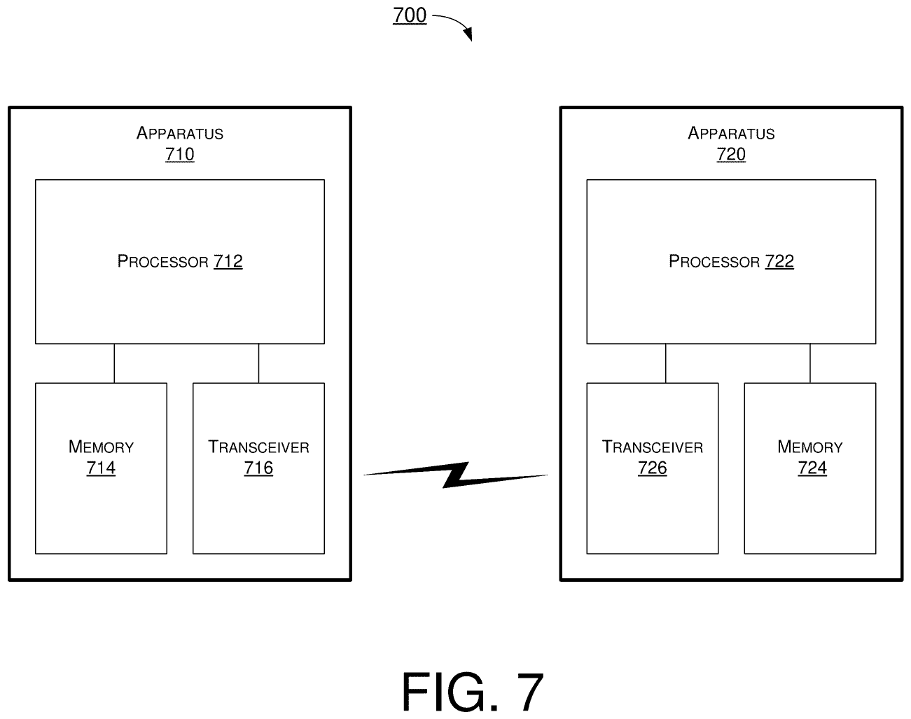

FIG. 7 illustrates an example communication system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to handling of in-order delivery and latency variation in mobile communications, including the various schemes described above with respect to various proposed designs, concepts, schemes, systems and methods described above, including network environment 100, as well as processes described below.

Each of apparatus 710 and apparatus 720 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 710 and apparatus 720 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in an eNB in an LTE, LTE-Advanced or LTE-Advanced Pro network or in a gNB or TRP in a 5G network, an NR network, or an IoT network.

In some implementations, each of apparatus 710 and apparatus 720 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 710 and apparatus 720 may be implemented in or as a network apparatus or a UE. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC or RISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged, and configured to perform specific tasks including those pertaining to handling of in-order delivery and latency variation in mobile communications in accordance with various implementations of the present disclosure.

In some implementations, apparatus 710 may also include a transceiver 716 coupled to processor 712. Transceiver 716 may be capable of wirelessly transmitting and receiving data. In some implementations, transceiver 716 may be capable of wirelessly communicating with different types of wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs/wireless networks of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a UE (e.g., UE 110), and apparatus 720, as a network node (e.g., network node 125) of a network (e.g., wireless network 120 as a 5G/NR mobile network), is provided below in the context of example process 800.

### Illustrative Processes

FIG. 8 illustrates an example process 800 in accordance with an implementation of the present disclosure. Process 800 may represent an aspect of implementing various proposed designs, concepts, schemes, systems and methods described above. More specifically, process 800 may represent an aspect of the proposed concepts and schemes pertaining to handling of in-order delivery and latency variation in mobile communications in accordance with the present disclosure. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively, in a different order. Furthermore, one or more of the blocks/sub-blocks of process 800 may be executed repeatedly or iteratively. Process 800 may be implemented by or in apparatus 710 and apparatus 720 as well as any variations thereof. Solely for illustrative purposes and without limiting the scope, process 800 is described below in the context of apparatus 710 as a UE (e.g., UE 110) and apparatus 720 as a communication entity such as a network node or base station (e.g., network node 125) of a network (e.g., wireless network 120). Process 800 may begin at block 810.

At 810, process 800 may involve processor 712 of apparatus 710, as UE 110, receiving, via transceiver 716, one or more packets from a network (e.g., wireless network 120 via apparatus 720 as network node 125). Process 800 may proceed from 810 to 820.

At 820, process 800 may involve processor 712 evaluating a local application-specific forwarding policy. Process 800 may proceed from 820 to 830.

At 830, process 800 may involve processor 712 forwarding at least one packet of the one or more packets to an application according to the application-specific forwarding policy.

In some implementations, the application-specific forwarding policy may involve forwarding immediately (e.g., without delay) upon receipt or forwarding out of order such that the application receives SDUs upon receipt by the UE and without the application waiting for reordering of packets.

In some implementations, the application-specific forwarding policy may include an application-controlled policy that helps a latency-sensitive application to cope with HARQ and one or more other retransmission mechanism-related latency variation in conjunction with an in-order delivery requirement.

In some implementations, in evaluating the local application-specific forwarding policy, process 800 may involve processor 712 implementing a channel for the application to control a modem packet forwarding policy regarding retransmission and reordering latencies.

In some implementations, in evaluating the local application-specific forwarding policy, process 800 may involve processor 712 performing certain operations. For instance, process 800 may involve processor 712 receiving a request from the application to apply the local application-specific forwarding policy by ignoring an in-order delivery requirement for SDUs matching a flow filter provided by the application. Additionally, process 800 may involve processor 712 matching the one or more packets to the flow filter. In some implementations, in receiving the request, process 800 may involve processor 712 receiving the request via an AT command.

In some implementations, in evaluating the local application-specific forwarding policy, process 800 may involve processor 712 performing other operations. For instance, process 800 may involve processor 712 receiving a request from a host operating system to apply the local application-specific forwarding policy by implementing out-of-order forwarding SDUs matching a flow filter. Moreover, process 800 may involve processor 712 matching the one or more packets to the flow filter.

In some implementations, in evaluating the local application-specific forwarding policy, process 800 may involve processor 712 performing different operations. For instance, process 800 may involve processor 712 receiving, via a user interface, a user configuration that configures an out-of-order forwarding policy to forward packets mating a match rule using the out-of-order forwarding policy. Furthermore, process 800 may involve processor 712 matching the one or more packets to the match rule.

In some implementations, process 800 may further involve processor 712 adjusting a modem forwarding policy for received packets responsive to a host setting up a virtual connection or a related filter with the local application-specific forwarding policy.

Alternatively, or additionally, process 800 may further involve processor 712 communicating, via transceiver 716, application parameters to the network. The application parameters may include values of a t-discard timer and a t-reorder timer.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), one or more packets from a network;
evaluating, by the processor, a local application-specific forwarding policy; and
forwarding, by the processor, at least one packet of the one or more packets to an application according to the application-specific forwarding policy.

2. The method of claim 1, wherein the application-specific forwarding policy involves forwarding immediately upon receipt or forwarding out of order such that the application receives service data units (SDUs) upon receipt by the UE and without the application waiting for reordering of packets.

3. The method of claim 1, wherein the application-specific forwarding policy comprises an application-controlled policy that helps a latency-sensitive application to cope with hybrid automatic repeat request (HARQ) and one or more other retransmission mechanism-related latency variation in conjunction with an in-order delivery requirement.

4. The method of claim 1, wherein the evaluating of the local application-specific forwarding policy comprises implementing a channel for the application to control a modem packet forwarding policy regarding retransmission and reordering latencies.

5. The method of claim 1, wherein the evaluating of the local application-specific forwarding policy comprises:
receiving a request from the application to apply the local application-specific forwarding policy by ignoring an in-order delivery requirement for service data units (SDUs) matching a flow filter provided by the application; and
matching the one or more packets to the flow filter.

6. The method of claim 5, wherein the receiving of the request comprise receiving the request via an AT command.

7. The method of claim 1, wherein the evaluating of the local application-specific forwarding policy comprises:
receiving a request from a host operating system to apply the local application-specific forwarding policy by implementing out-of-order forwarding for service data units (SDUs) matching a flow filter; and
matching the one or more packets to the flow filter.

8. The method of claim 1, wherein the evaluating of the local application-specific forwarding policy comprises:
receiving, via a user interface, a user configuration that configures an out-of-order forwarding policy to forward packets mating a match rule using the out-of-order forwarding policy; and
matching the one or more packets to the match rule.

9. The method of claim 1, further comprising:
adjusting, by the processor, a modem forwarding policy for received packets responsive to a host setting up a virtual connection or a related filter with the local application-specific forwarding policy.

10. The method of claim 1, further comprising:
communicating, by the processor, application parameters to the network,
wherein the application parameters comprise values of a t-discard timer and a t-reorder timer.

11. An apparatus implementable in a user equipment (UE), comprising:
a transceiver configured to communicate wirelessly; and
a processor coupled to the transceiver and configured to perform operations comprising:
receiving, via the transceiver, one or more packets from a network;
evaluating a local application-specific forwarding policy; and
forwarding at least one packet of the one or more packets to an application according to the application-specific forwarding policy.

12. The apparatus of claim 11, wherein the application-specific forwarding policy involves forwarding immediately upon receipt or forwarding out of order such that the application receives service data units (SDUs) upon receipt by the UE and without the application waiting for reordering of packets.

13. The apparatus of claim 11, wherein the application-specific forwarding policy comprises an application-controlled policy that helps a latency-sensitive application to cope with hybrid automatic repeat request (HARQ) and one or more other retransmission mechanism-related latency variation in conjunction with an in-order delivery requirement.

14. The apparatus of claim 11, wherein the evaluating of the local application-specific forwarding policy comprises implementing a channel for the application to control a modem packet forwarding policy regarding retransmission and reordering latencies.

15. The apparatus of claim 11, wherein the evaluating of the local application-specific forwarding policy comprises:
receiving a request from the application to apply the local application-specific forwarding policy by ignoring an in-order delivery requirement for service data units (SDUs) matching a flow filter provided by the application; and
matching the one or more packets to the flow filter.

16. The apparatus of claim 15, wherein the receiving of the request comprise receiving the request via an AT command.

17. The apparatus of claim 11, wherein the evaluating of the local application-specific forwarding policy comprises:
receiving a request from a host operating system to apply the local application-specific forwarding policy by implementing out-of-order forwarding for service data units (SDUs) matching a flow filter; and
matching the one or more packets to the flow filter.

18. The apparatus of claim 11, wherein the evaluating of the local application-specific forwarding policy comprises:
receiving, via a user interface, a user configuration that configures an out-of-order forwarding policy to forward packets mating a match rule using the out-of-order forwarding policy; and
matching the one or more packets to the match rule.

19. The apparatus of claim 11, wherein the processor is further configured to perform operations comprising:
adjusting a modem forwarding policy for received packets responsive to a host setting up a virtual connection or a related filter with the local application-specific forwarding policy.

20. The apparatus of claim 11, wherein the processor is further configured to perform operations comprising:
communicating, via the transceiver, application parameters to the network,
wherein the application parameters comprise values of a t-discard timer and a t-reorder timer.
